(19) United States
(12) Patent Application Publication
(10) Pub. No.: US 2023/0129270 A1
(43) Pub. Date: Apr. 27, 2023

(54) ANTI-REFLECTION FILM STRUCTURE AND COMPENSATION FILM WITH REVERSE WAVELENGTH DISPERSION CHARACTERISTICS

(71) Applicant: Sichuan Longhua Film Co., Ltd., Mianyang (CN)

(72) Inventors: RUIMIN DIAO, Mianyang (CN); YAO CHANG WANG, Zhubei City (TW)

(21) Appl. No.: 17/569,431

(22) Filed: Jan. 5, 2022

(30) Foreign Application Priority Data
Oct. 21, 2021 (CN) 202111227936.4

(51) Int. Cl. G02B 5/30

(52) U.S. Cl. CPC G02B 5/3083; G02B 5/3025

(57) ABSTRACT

An anti-reflection film structure comprising: a compensation film with reverse wavelength dispersion characteristics and a linear polarizer, the compensation film with reverse wavelength dispersion characteristics stretched from a monolithic polymer substrate, wherein the stretched monolithic polymer substrate has a thickness direction retardation value Rₜₕ(550), an in-plane retardation value Rₑ(450) and an in-plane retardation value Rₑ(550). Rₜₕ(550) is between 0 nm and 25 nm, and Rₑ(450)/Rₑ(550) is between 0.7 and 0.95. And the linear polarizer arranged on one side of the compensation film with reverse wavelength dispersion characteristics. In this anti-reflection film structure, the compensation film with reverse wavelength dispersion characteristics has an N_{z} coefficient of 0.5, and a single compensation film with reverse wavelength dispersion characteristics can achieve the effect of a conventional quarter-wavelength retardation film with a large viewing angle compensation film. Therefore, the anti-reflection structure has the advantages of being thinner and achieving the required optical performance.

### FIELD OF THE INVENTION

The present invention relates to an anti-reflection film structure, and more particularly to an anti-reflection film structure and a compensation film with reverse wavelength dispersion characteristics applied to an organic light-emitting diode display device.

### BACKGROUND OF THE INVENTION

In an optical display, the phase retardation film is usually used to correct the retardation of light to improve the display effect of the optical display. For example, in an organic light-emitting diode display (OLED display), the metal electrode easily reflects the natural light in the environment and causes its contrast to decrease. Therefore, a circular polarizer (can be used as an anti-reflective film) formed by a linear polarizer and a phase retardation film is usually bonded to the light-emitting surface to correct the retardation of the reflected natural light so that the natural light cannot be emitted from the light-emitting surface, thereby improving the problem of natural light reflection.

However, the phase retardation film in the conventional circular polarizer usually uses a quarter-wavelength retardation film and a large viewing angle compensation film as the structure. The quarter-wavelength retardation film is made by, for example, bonding two-piece polymer layers. The thickness of the quarter-wavelength retardation film is about 36 pm or more. The large viewing angle compensation film uses +C-plate (nₓ=n_{y}<n_{z}), and the thickness thereof is about 3 μm or more. The +C-plate is arranged on one side of the quarter-wavelength retardation film, so that the +C-plate can provide compensation for the large viewing angle of the phase retardation film. This kind of phase retardation film needing to be provided with a +C-plate has a complicated manufacturing process, a greater thickness, and poor weather resistance and reliability.

### SUMMARY OF THE INVENTION

The present invention provides an anti-reflection film structure and a compensation film with reverse wavelength dispersion characteristics. The compensation film with reverse wavelength dispersion characteristics has the advantage of being thinner and more stable weather resistance and reliability, thereby making the entire anti-reflection film structure has the advantages of having smaller thickness and good optical quality.

The anti-reflection film structure provided by the invention includes a compensation film with reverse wavelength dispersion characteristics and a linear polarizer. The compensation film with reverse wavelength dispersion characteristics is stretched from a monolithic polymer substrate. The stretched monolithic polymer substrate has a thickness direction retardation value Rₜₕ(550), an in-plane retardation value Rₑ(450) and an in-plane retardation value Rₑ(550). The thickness direction retardation value Rₜₕ(550) is between 0 nm and 25 nm, and Rₑ(450)/Rₑ(550) is between 0.7 and 0.95. The linear polarizer is arranged on one side of the compensation film with reverse wavelength dispersion characteristics.

In an embodiment of the present invention, the monolithic polymer substrate is a monolithic original film of polycarbonate (PC) material.

In an embodiment of the present invention, the thickness direction retardation value Rₜₕ(550) is 2.1 nm.

In an embodiment of the present invention, Rₑ(450)/Rₑ(550) is 0.82.

In an embodiment of the present invention, the in-plane retardation value Rₑ(550) is between 125 nm and 150 nm.

In an embodiment of the present invention, the stretched monolithic polymer substrate has an in-plane retardation value Rₑ(650), and Rₑ(650)/Rₑ(550) is between 1.01 and 1.1.

In an embodiment of the present invention, Rₑ(650)/Rₑ(550) is 1.06.

In an embodiment of the present invention, the thickness of the compensation film with reverse wavelength dispersion characteristics is between 20 μm and 36 μm.

In an embodiment of the present invention, an N_{z} coefficient of the compensation film with reverse wavelength dispersion characteristics is 0.5.

In an embodiment of the present invention, the anti-reflection film structure further includes a pressure sensitive adhesive, disposed between the compensation film with reverse wavelength dispersion characteristics and the linear polarizer.

The compensation film with reverse wavelength dispersion characteristics provided by the invention is stretched from a monolithic polymer substrate. The stretched monolithic polymer substrate has a thickness direction retardation value Rₜₕ(550), an in-plane retardation value Rₑ(450) and an in-plane retardation value Rₑ(550). The thickness direction retardation value Rₜₕ(550) is between 0 nm and 25 nm, and Rₑ(450)/Rₑ(550) is between 0.7 and 0.95.

In the anti-reflection film structure of the embodiment of the present invention, the compensation film with reverse wavelength dispersion characteristics realized by stretching a monolithic polymer substrate has an N_{z} coefficient of 0.5, and the thickness direction retardation value Rₜₕ(550) is between 0 nm and 25 nm. Without using the conventional large viewing angle compensation film, a single compensation film with reverse wavelength dispersion characteristics can achieve the effect of a quarter-wavelength retardation film with a large viewing angle compensation film. Moreover, the thickness of a single compensation film with reverse wavelength dispersion characteristics can be thinned to between 20 μm and 36 μm, which has the advantage of being thinner and achieving the required optical performance.

### BRIEF DESCRIPTION OF THE DRAWINGS

The present invention will become more readily apparent to those ordinarily skilled in the art after reviewing the following detailed description and accompanying drawings, in which:

FIG. 1 is a schematic cross-sectional view of an anti-reflection film structure according to an embodiment of the present invention; and

FIG. 2 is a schematic diagram of the relationship curve between wavelength (λ) and Rₑ(λ)/Rₑ(550) according to an embodiment of the present invention.

### DETAILED DESCRIPTION OF PREFERRED EMBODIMENTS

The definitions of terms and symbols in this specification are as follows:

(1) Refractive index (ny, n_{y}, n_{z}): nₓ is the refractive index in the direction that the refractive index in the plane is the largest (that is, the slow axis direction), n_{y} is the refractive index in the direction orthogonal to the slow axis in the plane (that is, the fast axis direction), and n_{z} is the refractive index in the thickness direction.

(2) The thickness direction retardation value(Rₜₕ): Rₜₕ(λ) is the thickness direction retardation value measured by light with a wavelength of λ nanometers (nm) at 23° C. For example, Rₜₕ(550) is a thickness direction retardation value measured by light with a wavelength of 550 nm at 23° C. When the thickness of the layer (film) is d (nm), Rₜₕ(λ) is obtained by the formula: Rₜₕ(λ)=[(nₓ+n_{y})/2−n_{z}]×d.

(3) The in-plane retardation value(Rₑ): Rₑ(λ) is an in-plane retardation value measured by light with a wavelength of λ nm at 23° C. For example, Rₑ(550) is an in-plane retardation value measured by light with a wavelength of 550 nm at 23° C. When the thickness of the layer (film) is d (nm), Rₑ(λ) is obtained by the formula: Rₑ(λ)=(nₓ−n_{y})×d.

(4) The N_{z} coefficient: N_{z} coefficient is obtained by the formula: N_{z}=(nₓ−n_{z})/(nₓ−n_{y}).

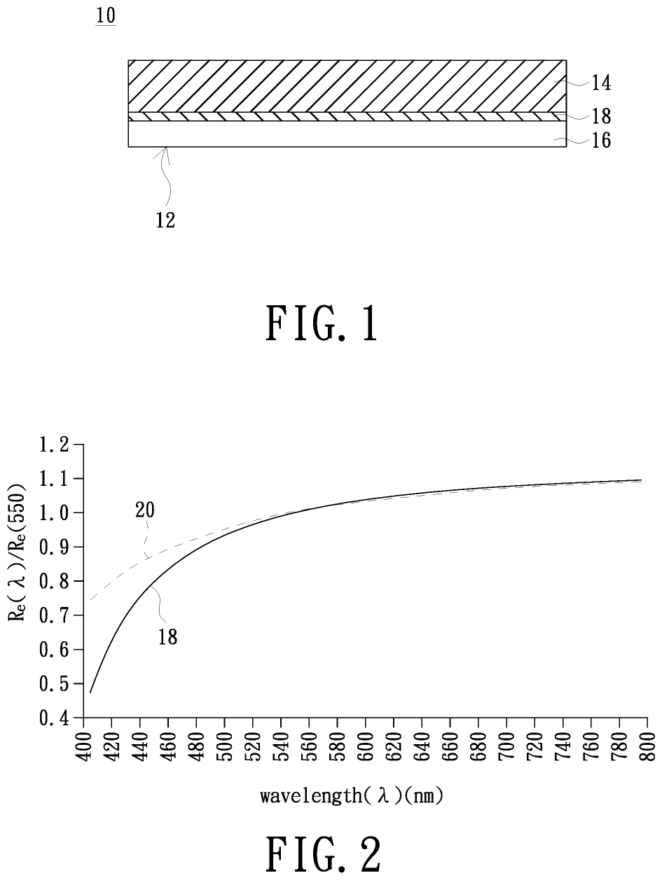

FIG. 1 is a schematic cross-sectional view of an anti-reflection film structure according to an embodiment of the present invention. As shown in the figure, the anti-reflection film structure 10 includes a compensation film 12 with reverse wavelength dispersion characteristics and a linear polarizer 14. The compensation film 12 with reverse wavelength dispersion characteristics is stretched from a monolithic polymer substrate 16, wherein the thickness direction retardation value Rₜₕ(550) of the stretched monolithic polymer substrate 16 is between 0 nm and 25 nm, and the ratio Rₑ(450)/Rₑ(550) of the in-plane retardation value Rₑ(450) to the in-plane retardation value Rₑ(550) is between 0.7 and 0.95. In addition, the linear polarizer 14 is arranged on one side of the compensation film 12 with reverse wavelength dispersion characteristics. In one embodiment, the anti-reflection film structure 10 further includes a pressure sensitive adhesive 18. The pressure sensitive adhesive 18 is disposed between the compensation film 12 with reverse wavelength dispersion characteristics and the linear polarizer 14.

The monolithic polymer substrate 16 is, for example, a monolithic original film of polycarbonate (PC) material. The stretched monolithic polymer substrate 16 has a thickness direction retardation value Rₜₕ(550), for example, between 0 nm to 5 nm, 5.1 nm to 10 nm, 10.1 nm to 15 nm, 15.1 nm to 20 nm, and 20.1 nm to 25 nm, wherein the thickness direction retardation value Rₜₕ(550) is preferably 2.1 nm. The Rₑ(450)/Rₑ(550) of the stretched monolithic polymer substrate 16 is preferably 0.82, and the in-plane retardation value Rₑ(550) is between 125 nm and 150 nm, and the in-plane retardation value Rₑ(550) is preferably 138.9 nm.

Continuing the above description, the stretched monolithic polymer substrate 16 has an in-plane retardation value Rₑ(650), and Rₑ(650)/Rₑ(550) is between 1.01 and 1.1, preferably, Rₑ(650)/Rₑ(550) is 1.06. In one embodiment, the thickness of the stretched and thinned monolithic polymer substrate 16 is between 20 μm and 36 μm, preferably, the thickness of the stretched and thinned monolithic polymer substrate 16 is 25 μm, and the N_{z} coefficient is 0.5.

In the anti-reflection film structure 10 of the embodiment of the present invention, the thinned compensation film 12 with reverse wavelength dispersion characteristics can be realized by stretching the monolithic polymer substrate 16. Both Rₑ(450)/Rₑ(550) and Rₑ(650)/Rₑ(550) are closer to the ideal curve of an ideal compensation film with reverse wavelength dispersion characteristics. FIG. 2 is a schematic diagram of the relationship curve between wavelength (λ) and Rₑ(λ)/Rₑ(550) according to an embodiment of the present invention. The solid line 18 is the relationship curve of the thinned compensation film 12 with reverse wavelength dispersion characteristics stretched from the monolithic polymer substrate 16 according to the embodiment of the present invention, and the dashed line 20 is the relationship curve of the conventional phase compensation film composed of a quarter-wavelength retardation film and a +C-plate. It can be clearly seen that in the short-wavelength range, the Rₑ(λ)/Rₑ(550) of the compensation film 12 with reverse wavelength dispersion characteristics of the embodiment of the present invention is closer to the ideal curve of an ideal compensation film with reverse wavelength dispersion characteristics.

Furthermore, in the anti-reflection film structure 10 of the embodiment of the present invention, the compensation film 12 with reverse wavelength dispersion characteristics realized by stretching a monolithic polymer substrate 16 has an N_{z} coefficient of 0.5, and the thickness direction retardation value Rₜₕ(550) is between 0 nm and 25 nm. Without using the conventional large viewing angle compensation film, a single compensation film 12 with reverse wavelength dispersion characteristics can achieve the effect of a quarter-wavelength retardation film with a large viewing angle compensation film. Moreover, the thickness of a single compensation film with reverse wavelength dispersion characteristics can be thinned to between 20 μm and 36 μm, which has the advantage of being thinner and achieving the required optical performance. In addition, the compensation film 12 with reverse wavelength dispersion characteristics is stretched from a monolithic polymer substrate 16, and the material of the compensation film 12 with reverse wavelength dispersion characteristics is, for example, a PC-based stretched material. Thus, compared with the conventional phase compensation film composed of a quarter-wavelength retardation film and a +C-plate, the compensation film 12 with reverse wavelength dispersion characteristics of the embodiment of the present invention has more stable weather resistance and reliability.

According to the above description, a single compensation film with reverse wavelength dispersion characteristics included in the anti-reflection film structure of the embodiment of the present invention can achieve the effect of a conventional quarter-wavelength retardation film with a large viewing angle compensation film. Therefore, the anti-reflection structure of the embodiment of the present invention has the advantages of being thinner and achieving the required optical performance.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An anti-reflection film structure comprising:
a compensation film with reverse wavelength dispersion characteristics, stretched from a monolithic polymer substrate, wherein the stretched monolithic polymer substrate has a thickness direction retardation value Rₜₕ(550), an in-plane retardation value Rₑ(450) and an in-plane retardation value Rₑ(550), the thickness direction retardation value Rₜₕ(550) is between 0 nm and 25 nm, and Rₑ(450)/Rₑ(550) is between 0.7 and 0.95; and
a linear polarizer, arranged on one side of the compensation film with reverse wavelength dispersion characteristics.

2. The anti-reflection film structure according to claim 1, wherein the monolithic polymer substrate is a monolithic original film of polycarbonate material.

3. The anti-reflection film structure according to claim 1, wherein the thickness direction retardation value Rₜₕ(550) is 2.1 nm.

4. The anti-reflection film structure according to claim 1, wherein Rₑ(450)/Rₑ(550) is 0.82.

5. The anti-reflection film structure according to claim 1, wherein the in-plane retardation value Rₑ(550) is between 125 nm and 150 nm.

6. The anti-reflection film structure according to claim 1, wherein the stretched monolithic polymer substrate has an in-plane retardation value Rₑ(650), and Rₑ(650)/Rₑ(550) is between 1.01 and 1.1.

7. The anti-reflection film structure according to claim 1, wherein Rₑ(650)/Rₑ(550) is 1.06.

8. The anti-reflection film structure according to claim 1, wherein the thickness of the compensation film with reverse wavelength dispersion characteristics is between 20 μm and 36 μm.

9. The anti-reflection film structure according to claim 1, wherein an N_{z} coefficient of the compensation film with reverse wavelength dispersion characteristics is 0.5.

10. The anti-reflection film structure according to claim 1, further comprising a pressure sensitive adhesive, disposed between the compensation film with reverse wavelength dispersion characteristics and the linear polarizer.

11. A compensation film with reverse wavelength dispersion characteristics, wherein the compensation film with reverse wavelength dispersion characteristics is stretched from a monolithic polymer substrate, the stretched monolithic polymer substrate has a thickness direction retardation value Rₜₕ(550), an in-plane retardation value Rₑ(450) and an in-plane retardation value Rₑ(550), the thickness direction retardation value Rₜₕ(550) is between 0 nm and 25 nm, and Rₑ(450)/Rₑ(550) is between 0.7 and 0.95.
